(19) United States
(12) Patent Application Publication
(10) Pub. No.: US 2009/0223201 A1
(43) Pub. Date: Sep. 10, 2009

(54) Methods of Injecting Diluent Into A Gas Turbine Assembly

(76) Inventors: Ashok K. Anand, Niskayuna, NY (US); Benjamin A. Mancuse, Schenectady, NY (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/045,497

(22) Filed: Mar. 10, 2008

(51) Int. Cl. F02C 3/20

(52) U.S. Cl. 60/39.461

(57) ABSTRACT

Methods for injecting diluents into a gas turbine assembly of an integrated combined-cycle (IGCC) plant are disclosed. Specifically, the methods include injecting a diluent into an air stream to dilute the oxygen content of the air stream; and channeling the diluted air stream into a main air compressor for compression.

### BACKGROUND OF THE DISCLOSURE

The field of the invention relates generally to gasification systems, such as gasification systems used in an integrated gasification combined-cycle (IGCC) power generation plant, and more particularly, to methods of injecting diluent into a gas turbine assembly used in an IGCC power generation plant.

Most known IGCC plants include a gasification system that is integrated with at least one power-producing turbine assembly. For example, at least some known gasification systems convert a mixture of fuel, air or oxygen, steam, and/or CO₂ into a synthesis gas, or “syngas.” The syngas is channeled to the combustor of a gas turbine engine, which powers an electrical generator that supplies electrical power to a power grid. Exhaust from at least some known gas turbine engines is supplied to a heat recovery steam generator (HRSG) that generates steam for driving a steam turbine. Power generated by the steam turbine also drives an electrical generator that provides electrical power to the power grid.

In many IGCC plants, diluents, such as waste gaseous nitrogen from air separation plants, are injected to reduce nitrogen oxide emissions and/or to increase power output. Conventionally, diluents, such as nitrogen, have been compressed to fuel delivery pressure and have been added to either the fuel stream or injected directly into the gas turbine combustor in the combustion zone to reduce nitrogen oxide emissions. In some embodiments, additional gaseous diluent has also been injected in the combustor dilution zone as needed to increase gas turbine power output. This latter use of diluent requires a gaseous diluent compressor that has a high enough discharge pressure to adequately deliver diluent for mixing with the fuel stream prior to the mixture being injected into the fuel control valve, and/or requires a separate diluent injection control valve for injection into the gas turbine combustor. In both known methods, high compression power by the diluent compressor, along with high purity diluent with very low oxygen content, i.e., typically less than 2%, is required to avoid damage to hardware in the event of flash back in syngas fuel combustion. However, such systems are generally expensive and may have only limited effectiveness.

### BRIEF DESCRIPTION OF THE DISCLOSURE

The present disclosure relates to methods for injecting diluents into a gas turbine assembly of an integrated gasification combined-cycle (IGCC) plant to reduce nitrogen oxide emissions and improve plant thermal efficiency. Specifically, in one embodiment, the method includes injecting a compressed diluent into the main air compressor discharge line to mix with a compressed air stream. In another embodiment, the method includes injecting the diluent directly into the main air compressor with an air stream. In one further embodiment, a method of injecting diluent into a gas turbine assembly of an IGCC plant is provided in such a manner as to provide for cooling of the turbine hot parts cooling air circuits.

As such, in one aspect, a method of injecting a diluent into a gas turbine assembly is provided. The method includes channeling an air stream into a first compressor for compression; injecting a diluent into a diluent compressor for compression; and channeling the compressed diluent into a compressed air stream discharged from the first compressor discharge line.

In another aspect, a method of injecting a diluent into a gas turbine assembly is provided. The method includes injecting a diluent into an air stream to facilitate diluting an oxygen content of the air stream; and channeling the diluted air stream into a first compressor for compression.

In a further aspect, a method of injecting a diluent into a gas turbine assembly is provided. The method includes channeling a diluent into a diluent compressor for compression; discharging the compressed diluent into at least one cooling line; and routing the compressed diluent downstream to facilitate cooling a portion of the gas turbine assembly.

Other objects and features will be in part apparent and in part pointed out hereinafter.

### BRIEF DESCRIPTION OF THE DRAWINGS

FIG. 1 is a schematic diagram of an exemplary integrated gasification combined-cycle (IGCC) power generation plant; and

FIG. 2 is a schematic diagram of a gas turbine assembly and a diluent injection system used with the IGCC power generation plant shown in FIG. 1.

### DETAILED DESCRIPTION OF THE DISCLOSURE

The present disclosure is generally directed to improved methods of injecting diluent into a gas turbine assembly. In one embodiment, the diluent is introduced into the gas turbine assembly to facilitate diluting nitrogen oxide emissions and, more particularly, the oxygen content of the compressed air stream used for combustion in the gas turbine. In an alternative embodiment, the diluent is injected into the gas turbine assembly to facilitate cooling turbine components.

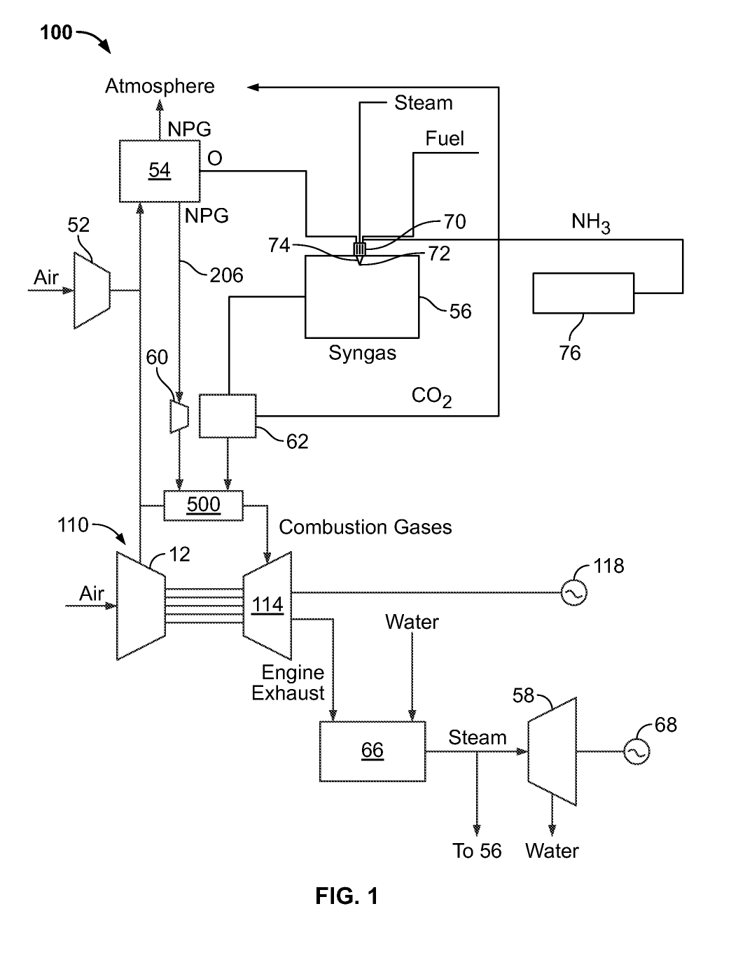

FIG. 1 is a schematic diagram of an exemplary integrated gasification combined-cycle (IGCC) power generation plant 100. IGCC system 100 generally includes a main air compressor 52, an air separation unit 54 coupled in flow communication to compressor 52, a gasifier 56 coupled in flow communication to air separation unit 54, a gas turbine assembly 110, coupled in flow communication to gasifier 56, and a steam turbine 58. In operation, compressor 52 compresses ambient air. The compressed air is channeled to air separation unit 54. In some embodiments, in addition or alternative to compressor 52, compressed air from gas turbine assembly compressor 12 is supplied to air separation unit 54. Air separation unit 54 uses the compressed air to generate oxygen for use by gasifier 56. More specifically, air separation unit 54 separates the compressed air into separate flows of oxygen and a gas by-product, sometimes referred to as a “process gas.” The process gas generated by air separation unit 54 includes nitrogen and will be referred to herein as “nitrogen process gas.” The nitrogen process gas may also include other gases such as, but not limited to, oxygen and/or argon. For example, in some embodiments, the nitrogen process gas includes between about 90% (by weight) and about 100% (by weight), and more particularly, between about 95% (by weight) and about 100% (by weight) nitrogen. The oxygen flow is channeled to gasifier 56 for use in generating partially combusted gases, referred to herein as “syngas” for use by gas turbine assembly 110 as fuel, as described below in more detail. In some known IGCC systems 100, at least some of the nitrogen process gas flow, a by-product of air separation unit 54, is vented to the atmosphere. Moreover, in some known IGCC systems 100, some of the nitrogen process gas flow is injected into a combustion zone (not shown) within gas turbine engine combustor 500 to facilitate controlling emissions of assembly 110, and more specifically to facilitate reducing the combustion temperature and reducing nitrogen oxide emissions from assembly 110. IGCC system 100 may include a compressor 60 for compressing the nitrogen process gas flow before being injected into the combustion zone.

Gasifier 56 converts a mixture of fuel, the oxygen supplied by air separation unit 54, liquid water and/or steam, and/or slag additive into an output of syngas for use by gas turbine assembly 110 as fuel. Although gasifier 56 may use any fuel, in some known IGCC systems 100, gasifier 56 uses coal, petroleum coke, residual oil, oil emulsions, tar sands, and/or other similar fuels. In some known IGCC systems 100, the syngas generated by gasifier 56 includes carbon dioxide. The syngas generated by gasifier 56 may be cleaned in a clean-up device 62 before being channeled to gas turbine assembly combustor 500 for combustion thereof. Carbon dioxide may be separated from the syngas during clean-up and, in some known IGCC systems 100, vented to the atmosphere. The power output from gas turbine assembly 110 drives a generator 118 that supplies electrical power to a power grid (not shown). Exhaust gas from gas turbine assembly 110 is supplied to a heat recovery steam generator 66 that generates steam for driving steam turbine 58. Power generated by steam turbine 58 drives an electrical generator 68 that provides electrical power to the power grid. In some known IGCC systems 100, steam from heat recovery steam generator 66 is supplied to gasifier 56 for generating the syngas.

While as noted above, IGCC power generation plant 100 includes air separation unit 54 to separate N₂, O₂, and other gases components (e.g., argon and the like), it should be recognized, as noted above, that conduit 206 does not transport pure N₂; that is, there is remnant O₂ and other components present in the air stream transported via conduit 206. For example, it has been found that the separated air stream channeled through conduit 206 typically contains about 95% or more (by weight) of nitrogen and about 5% (by weight) or less of other gaseous components, such as oxygen and argon. It has long been recognized that when combusting syngas using an air supply having a relatively high oxygen content, i.e., typically greater than 2%, the risk of damage to components of IGCC power generation plant 100, due to flash back, in syngas fuel combustion is increased. As such, with at least some known IGCC plants, one or more diluents (not shown) have been added to the syngas fuel (not shown) prior to being combusted.

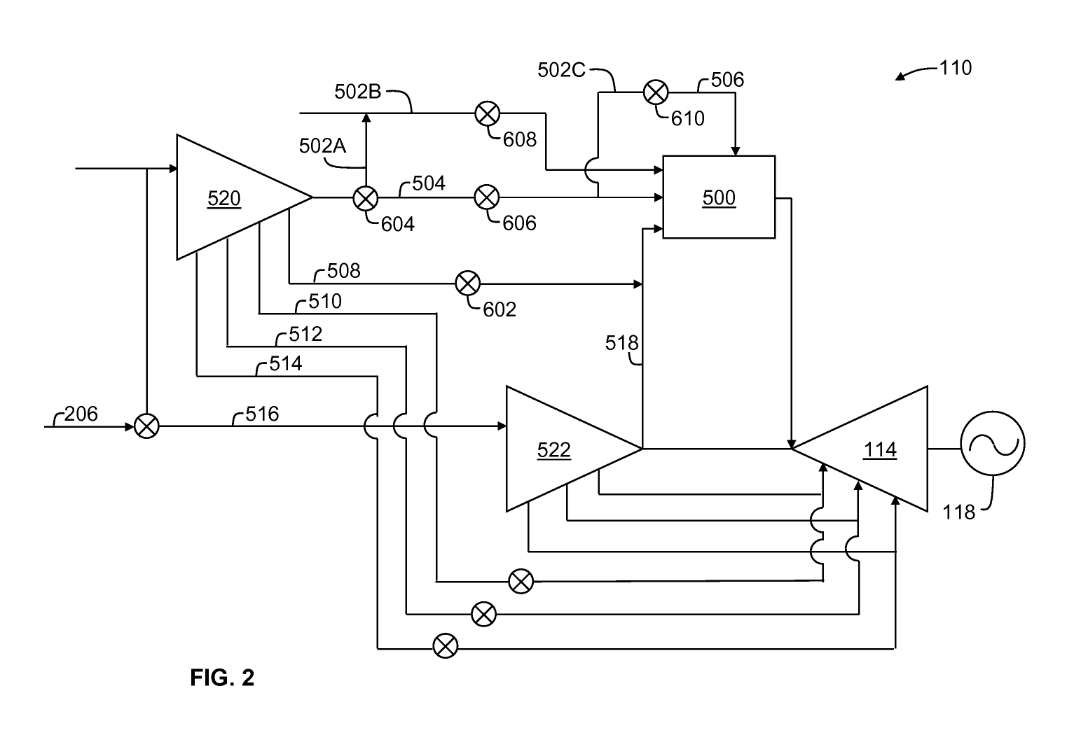

FIG. 2 is a schematic diagram of an exemplary gas turbine assembly 110 used with IGCC power generation plant 100 (shown in FIG. 1). Particularly, in the exemplary embodiment, gas turbine assembly 110 includes gas turbine 114 and first electrical generator 118, as described above. Conventionally, one or more diluents have either been added to the syngas fuel stream upstream from a combustor 500, generally indicated at 502A, 502B, and 502C, or have been added directly to various stages of the combustor (to be combusted with the syngas fuel and the compressed air stream described below) through conduit 504 and/or conduit 506. As described above, such injection methods are generally inefficient and costly. Specifically, with known injection methods, the main air stream is generally not effectively diluted prior to combustion, and the main air stream includes higher levels of oxygen (typically greater than 21 mole percent of oxygen), which may cause flash back.

Typical diluents for use in gas turbine assembly 110 such as used in IGCC power generation plant 100 and similar processes include, for example, nitrogen, steam, and carbon dioxide. Particularly preferred diluent for use in the present invention is nitrogen as it is separated from oxygen under pressure in air separation unite 54. These diluents can be added in amounts of up to about three times the amount of fuel gas used in gas turbine assembly 110 so as to reduce the combustion flame temperatures and associated nitrogen oxide emissions in combustor 500. The methods of the present invention provide improved diluent injection conduits 508, 510, 512, 514, and 516 for use in more efficiently injecting diluent into gas turbine assembly 110. Specifically, in one embodiment, one or more diluents are initially introduced into diluent compressor 520, wherein the diluent, such as available from air separation unit 54, normally at a pressure of one-third of the compressed air stream entering main air compressor 522, is compressed from a pressure of about 60 pounds per square inch absolute (psia) to a pressure of about 300 psia.

As the diluent is compressed in compressor 520, the main air stream, which has been separated by air separation unit 54 (shown in FIG. 1) to contain at least about 95% (by weight) nitrogen and less than about 5% (by weight) oxygen and/or argon, is channeled via conduit 206 to main air compressor 522 wherein the main air stream is compressed. Typically, the main air stream is compressed in main air compressor 522 from ambient air having a pressure ranging from about 13 psia to 14.7 psia to a pressure of from about 150 psia to 350 psia, depending upon the compressor design of gas turbine assembly 110. Once compressed, the main air stream is discharged from main air compressor 522 to combustor 500 via compressor discharge conduit 518.

The compressed diluent is mixed with the compressed main air stream. As the diluent is introduced into the main air stream at compressor discharge conduit 518, the diluent need not have the stringent pressure requirements as it would otherwise require. Specifically, stringent diluent pressure requirements depend upon the location of injection of the diluent and its role in achieving nitrogen oxide emissions. Typically, the diluent pressure must be higher than that required for all operating conditions of combustor 500. More particularly, during conventional methods, a higher pressure, generally from about 30% to about 60% above the pressure at the injection point, is generally required of any material being injected into the combustor to account for pressure losses due to one or more flow control valve 602, 604, 606, 608, and 610 and adequate distribution of the diluent such as for injection via nozzles (not shown) both in the gas turbine fuel stream and directly into combustor 500. Using the injection methods of the present invention, however, requires the diluent pressure to be only 10% to about 15% above the pressure at the injection location point in the compressor discharge conduit 518, as it has adequate time and space for mixing with the compressed discharge air stream.

In another embodiment, diluent is introduced directly and the air stream, once separated by air separation unit 54, entering gas turbine assembly 110 via conduit 206. Specifically, diluent is introduced directly into the main air stream in conduit 206. Once mixed, the diluted air stream is channeled to main air compressor 522 and is further compressed. Once compressed, the main air stream is channeled to the main air compressor 522 and to combustor 500 via compressor discharge conduit 518 for combustion with syngas fuel.

Generally, by introducing diluent into gas turbine assembly 110 using the methods of the present invention, the diluted compressed air stream (which, typically is then combusted and sent to gas turbine 114 to produce energy, as described more fully herein) includes less than about 21 mole percent oxygen. In one embodiment, the diluted compressed air includes from about 10 mole percent to about 15 mole percent oxygen. As noted above, by reducing the oxygen content, the risks of flash back are facilitated to be reduced during combustion.

Gas turbine combustor 500 is designed specifically with fuel nozzles (not shown) creating large pressure drops to increase their flow velocity in all operating conditions in the combustion zone to burn with air from the compressed discharge air stream. In a typical gas turbine, the fuel flow is typically less than air flow, typically, about 2% to about 10% of the air flow. The combustors are therefore designed with very low pressure drop in the air flow circuit to reduce losses and improve gas turbine efficiency. Flash back can only occur in the combustion area where the fuel is allowed to meet the compressed discharge air stream from discharge line (also referred to herein as discharge conduit) 518. In the improved diluent injection circuits of the present invention, however, diluent is mixed with the air stream in locations earlier than the locations in the combustor where diluent injection is conventionally applied.

As described above, once diluted, the diluted compressed air stream (typically at a temperature from about 400° F. to about 1000° F.) is injected into combustor 500 and is combusted along with a fuel source (typically, syngas fuel, typically at a temperature of about 250° F. to about 500° F.) at a temperature of from about 2000° F. to about 3500° F. and a pressure of from about 100 psia to about 350 psia. More suitably, the diluted compressed air stream is combusted along with a fuel source at a temperature of about 2500° F. and a pressure of about 230 psia. Once combusted, the resulting combustion gases are channeled towards turbine 114 to produce energy for first electrical generator 118.

In an alternative embodiment, the diluent can act as an alternative cooling agent as compared to conventional means of cooling hot turbine components (not shown) of gas turbine assembly 110. More particularly, gas turbine assemblies must generally be cooled to prevent overheating and malfunctioning. For example, in some known gas turbine assemblies, cool air (having a temperature of from about 500° F. to about 1000° F., and more suitably, about 800° F.) is supplied through conduits 510, 512, and 514 to facilitate cooling turbine components. Furthermore, compressed air from main air compressor 522 can be channeled to various components (e.g., via conduits 510, 512, and 514) of gas turbine assembly 110 to facilitate cooling. Typically, by cooling gas turbine assembly 110 in the above-described conventional manners, temperatures of various gas turbine assembly components can range from about 500° F. to about 1000° F.

In the present disclosure, however, the diluent can be compressed as described above in diluent compressor 520 and then be channeled directly to conduits 510, 512, and 514 to supplement cooling of turbine components within gas turbine assembly 110. By injecting diluent in this manner, lower pressures are required as compared to conventional pressures of cooling air streams. Specifically, the cooling air is conventionally supplied from discrete internal location circuits of main air compressor 522 for all operating conditions, while the diluent from diluent compressor 520 can be designed according to the present invention to be supplied directly at required operating pressures of turbine cooling circuits. The diluent typically is available at much lower temperature (typically, ambient temperature (˜60° F.)) and a higher pressure (typically, about 60 psia) before it is introduced in diluent compressor 520. Similarly, the diluent outlet temperature is typically from about 200° F. to about 500° F. lower at the same pressure conditions as the compressed air from main air compressor 522. Furthermore, using the injection method of the present invention facilitates cooling of gas turbine assembly components to temperatures that are cooler in comparison to temperatures obtainable using known turbine cooling schemes. For example, in one embodiment, the turbine components cooled by the methods of the present invention are cooled to temperatures of from about 400° F. to about 800° F.

Based on the foregoing, the present invention provides improved methods for injecting diluents into a gas turbine assembly of an IGCC plant. Specifically, the diluents can better remove excess oxygen (in the form of nitrogen oxide emissions) from the main air stream, prior to combustion as compared to conventional methods to prevent damaging hardware of gas turbine assemblies used in an IGCC power generation plant. More particularly, these improved dilution injection methods may especially be suitable for use in future IGCC plants, in which carbon from fuel is removed as carbon dioxide for sequestration resulting in a gas turbine fuel which is much higher in hydrogen (e.g., approximately 50% by volume or more). Specifically, in these future plants, injecting diluents under these conditions with even a small amount of oxygen (e.g., less than about 0.5% by volume) could cause flash back in the combustor components. Furthermore, the diluents can be used as an alternative or supplemental cooling agent to provide more efficient and effective cooling to hot turbine parts of the gas turbine assemblies.

When introducing elements of the present disclosure or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the disclosure, it is intended that all matter contained in the above description and shown in the accompanying drawings shall be interpreted as illustrative and not in a limiting sense.

What is claimed is:

1. A method of injecting diluent into a gas turbine assembly, said method comprising:
channeling an air stream into a first compressor for compression;
injecting a diluent into a diluent compressor for compression; and
channeling the compressed diluent into a compressed air stream discharged from the first compressor to dilute the oxygen content of the compressed air stream.

2. The method as set forth in claim 1 further comprising supplying the diluted compressed air stream and a fuel source to a combustor for combustion.

3. The method as set forth in claim 2 further comprising discharging combustion gases from the combustor to a gas turbine.

4. The method as set forth in claim 2, wherein supplying the diluted compressed air stream further comprises supplying an air stream to the combustor that includes at least about 95 mole percent nitrogen.

5. The method as set forth in claim 4, wherein supplying the diluted compressed air stream further comprises supplying an air stream to the combustor that includes at least one of oxygen and argon.

6. The method as set forth in claim 2, wherein supplying the diluted compressed air stream further comprises supplying an air stream to the combustor that includes less than 21 mole percent oxygen.

7. The method as set forth in claim 2, wherein supplying the diluted compressed air stream further comprises supplying an air stream to the combustor that includes from about 10 mole percent to about 15 mole percent oxygen.

8. A method of injecting diluent into a gas turbine assembly, said method comprising:
injecting a diluent into an air stream to facilitate diluting an oxygen content of the air stream; and
channeling the diluted air stream into a first compressor for compressing the diluted air stream.

9. The method as set forth in claim 8 further comprising:
discharging the diluted compressed air stream from the first compressor towards a combustor; and
mixing the diluted compressed air stream and a fuel source for combustion.

10. The method as set forth in claim 9, further comprising discharging combustion gases from the combustor to a gas turbine.

11. The method as set forth in claim 10, wherein discharging the diluted compressed air stream further comprises discharging an air stream to the combustor that includes at least about 95 mole percent nitrogen.

12. The method as set forth in claim 11, wherein discharging the diluted compressed air stream further comprises discharging an air stream to the combustor that includes at least one of oxygen and argon.

13. The method as set forth in claim 10, wherein discharging the diluted compressed air stream further comprises discharging an air stream to the combustor that includes less than 21 mole percent oxygen.

14. The method as set forth in claim 10, wherein discharging the diluted compressed air stream further comprises discharging an air stream to the combustor that includes from about 10 mole percent to about 15 mole percent oxygen.

15. A method of injecting diluent into a gas turbine assembly to facilitate cooling the assembly, said method comprising:
channeling a diluent into a diluent compressor for compression;
discharging the compressed diluent into at least one cooling line; and
routing the compressed diluent downstream to facilitate cooling a portion of the gas turbine assembly.

16. The method as set forth in claim 15, wherein the discharging of the compressed diluent includes introducing the compressed diluent into a first cooling line, a second cooling line, and a third cooling line, wherein the first cooling line, second cooling line, and third cooling line independently connect the diluent compressor to the gas turbine.
